(19) United States
(12) Patent Application Publication
(10) Pub. No.: US 2017/0238529 A1
(43) Pub. Date: Aug. 24, 2017

(54) Fowl Decoy Assembly

(71) Applicant: Don Norwood, Cifton, TN (US)

(72) Inventor: Don Norwood, Cifton, TN (US)

(21) Appl. No.: 15/052,836

(22) Filed: Feb. 24, 2016

(51) Int. Cl. A01M 31/06; F16M 13/00

(52) U.S. Cl. CPC A01M 31/06; F16M 13/00

(57) ABSTRACT

A fowl decoy assembly includes a decoy that includes a body of a female bird and a body of a male bird. A head is movably coupled to the body corresponding to the male bird. The male bird is positioned to mount the female bird. A string is coupled to the decoy and the string may be manipulated. A stand is provided to penetrate a support surface. The decoy is removably coupled to the stand such that the stand retains the decoy in a natural position.

### BACKGROUND OF THE DISCLOSURE

Field of the Disclosure

The disclosure relates to decoy devices and more particularly pertains to a new decoy device for luring a turkey for hunting.

### SUMMARY OF THE DISCLOSURE

An embodiment of the disclosure meets the needs presented above by generally comprising a decoy that includes a body of a female bird and a body of a male bird. A head is movably coupled to the body corresponding to the male bird. The male bird is positioned to mount the female bird. A string is coupled to the decoy and the string may be manipulated. A stand is provided to penetrate a support surface. The decoy is removably coupled to the stand such that the stand retains the decoy in a natural position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a fowl decoy assembly according to an embodiment of the disclosure.

FIG. 2 is a right side view of an embodiment of the disclosure.

FIG. 3 is a back view of an embodiment of the disclosure.

FIG. 4 is a cross sectional view taken along line 4-4 of FIG. 5 of an embodiment of the disclosure.

FIG. 5 is a perspective in-use view of an embodiment of the disclosure.

### DESCRIPTION OF THE PREFERRED EMBODIMENT

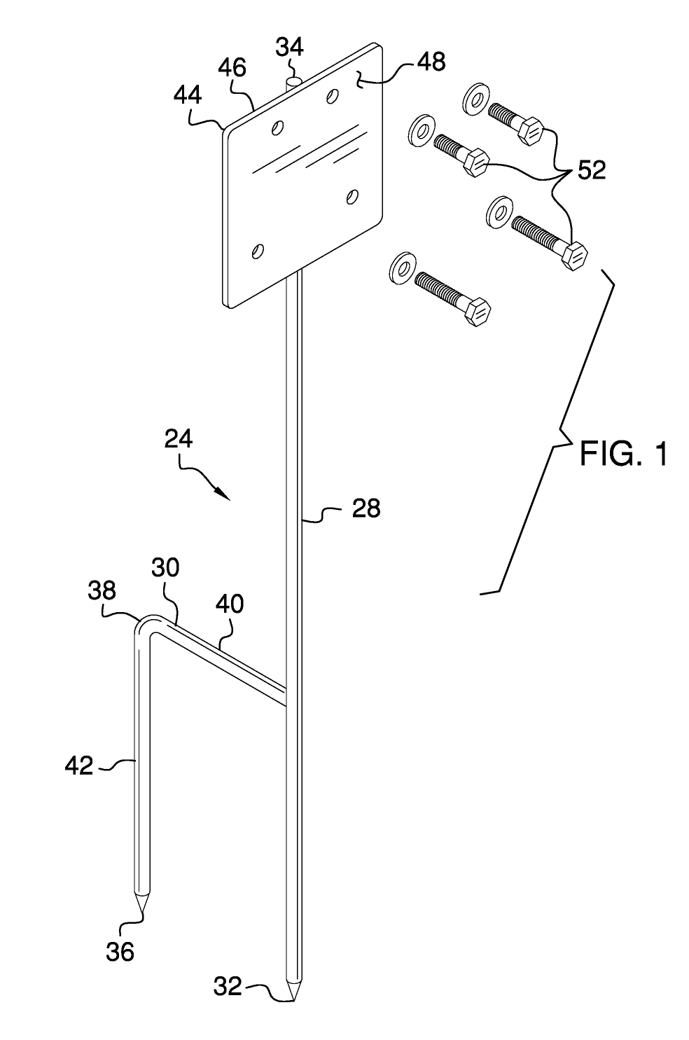

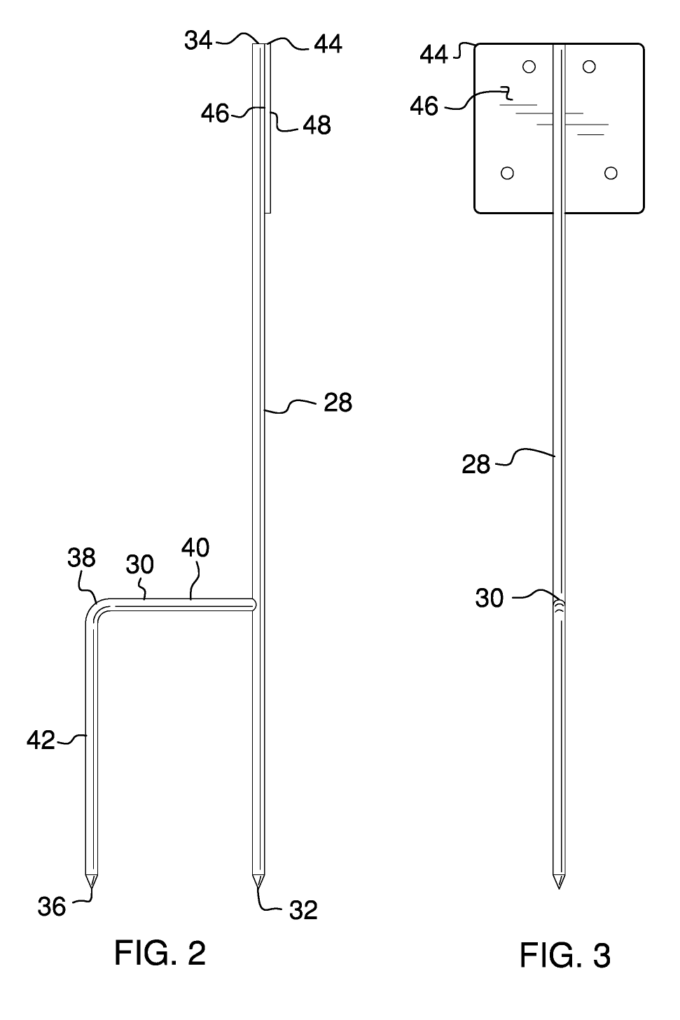

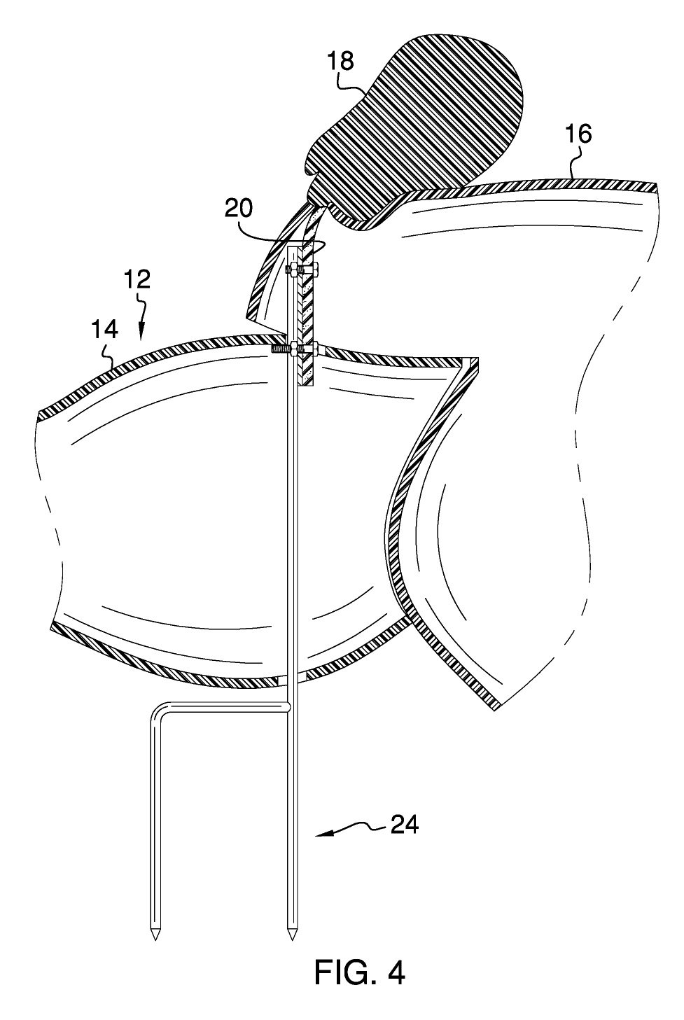

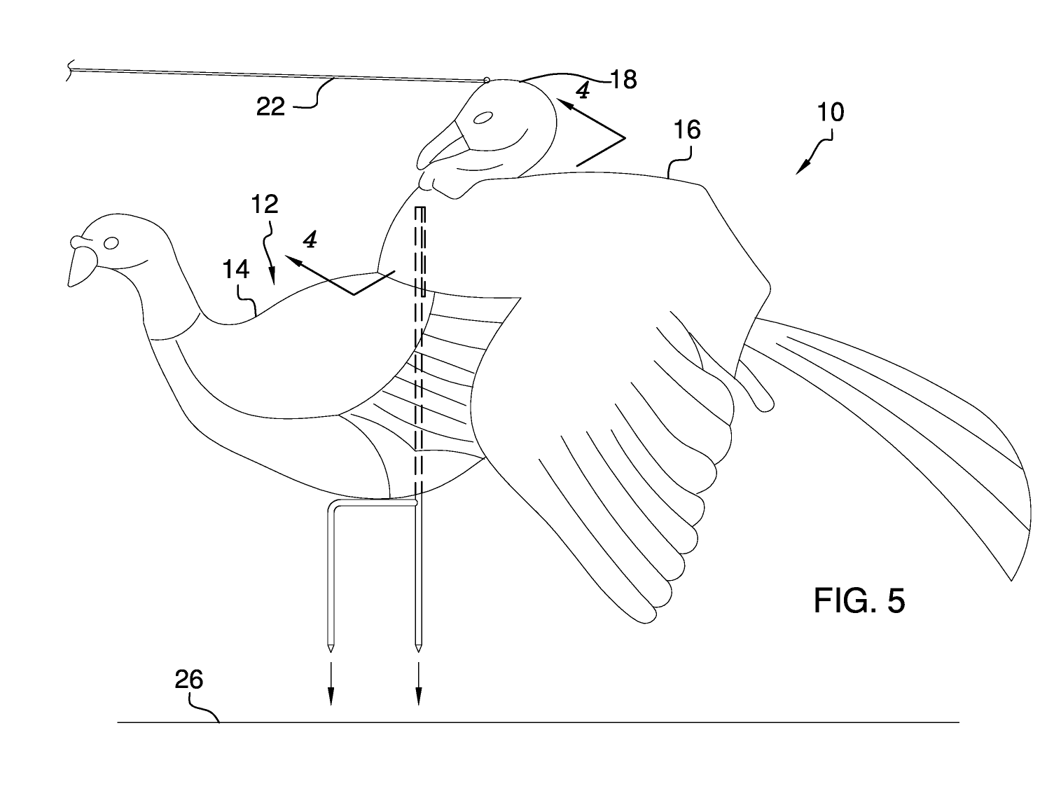

With reference now to the drawings, and in particular to FIGS. 1 through 5 thereof, a new decoy device embodying the principles and concepts of an embodiment of the disclosure and generally designated by the reference numeral 10 will be described.

As best illustrated in FIGS. 1 through 5, the fowl decoy assembly 10 generally comprises a decoy 12 that includes a body of a female bird 14 and a body of a male bird 16. A head 18 is movably coupled to the body of male bird 16. The male bird 16 is positioned to mount the female bird 14 during mating. A flap 20 is coupled to the head 18 and the flap 20 is positioned within the body of the male bird 16. The body of the female bird 14 and the body of the male bird 16 may each have the ornamental appearance of a turkey.

A string 22 is coupled to the decoy 12 and the string 22 may be manipulated. The string 22 is coupled to the head 18. Thus, the string 22 urges the head 18 to move back and forth when the string 22 is manipulated. Thus, the decoy 12 mimics mating motions of the male bird 16. A stand 24 is provided to penetrate a support surface 26. The decoy 12 is removably coupled to the stand 24 such that the stand 24 retains the decoy 12 in a natural position. The support surface 26 may comprise ground.

The stand 24 comprises a first stake 28 and a second stake 30. The first stake 28 has a bottom end 32 and a top end 34. The bottom end 32 tapers to a point to penetrate the support surface 26. The second stake 30 is coupled to the first stake 28 and the second stake 30 has a distal end 36 with respect to the first stake 28.

The second stake 30 has a bend 38 thereon to define a first portion 40 forming an angle with a second portion 42. The first portion 40 is coupled to and extends laterally away from the first stake 28. The second portion 42 is oriented parallel with the first stake 28. The distal end 36 tapers to a point to penetrate the support surface 26. Thus, the second stake 30 inhibits the stand 24 from tipping.

A plate 44 is provided that has a first surface 46 and a second surface 48. The first surface 46 is coupled to the first stake 28 and the plate 44 is aligned with the top end 34. The plate 44 has a plurality of apertures 50 extending through the first surface 46 and the second surface 48. The apertures 50 are spaced apart from each other on the plate 44.

The first stake 28 extends upwardly through the body of the female bird 14 and the plate 44 is aligned with the flap 20. A plurality of bolts 52 is provided. Each of the bolts 52 extends through the flap 20 and an associated one of the apertures 50. Thus, the flap 20 is removably coupled to the second surface 48.

In use, the first stake 28 is extended into the decoy 12 and the flap 20 is coupled to the plate 44. The bottom end 32 of the first stake 28 and the distal end 36 of the second stake 30 are urged into the support surface 26 at a selected location. The string 22 is manipulated from a remote location with respect to the decoy 12. Thus, the decoy 12 mimics mating actions between the male bird 16 and the female bird 14. The decoy 12 facilitates a hunter to lure a turkey into the selected location.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fowl decoy assembly comprising:
a decoy comprising a body of a female bird and a body of a male bird, said male bird having a head being movably coupled to said body corresponding to said male bird, said male bird being positioned to mount said female bird,
a string being coupled to said decoy wherein said string is configured to be manipulated; and
a stand being configured to penetrate a support surface, said decoy being removably coupled to said stand such that said stand retains said decoy in a natural position.

2. The assembly according to claim 1, wherein:
said decoy has a flap being coupled to said head, said flap being positioned within said body corresponding to said male bird; and
said string being coupled to said head such that said string urges said head to move back and forth when said string is manipulated such that said decoy mimics mating motion of said male bird.

3. The assembly according to claim 1, wherein said stand comprises:
a first stake having a bottom end and a top end, said bottom end tapering to a point wherein said bottom end is configured to penetrate the support surface; and
a second stake being coupled to said first stake, said second stake having a distal end with respect to said first stake, said second stake having a bend thereon to define a first portion forming an angle with a second portion, said first portion being coupled to and extending laterally away from said first stake having said second portion being oriented parallel with said first stake, said distal end tapering to a point wherein said distal end is configured to penetrate the support surface, said second stake inhibiting said stand from tipping.

4. The assembly according to claim 3, further comprising:
a flap being coupled to said decoy; and
a plate having a first surface and a second surface, said first surface being coupled to said first stake, said plate being aligned with said top end, said plate having a plurality of apertures extending through said first surface and said second surface, said apertures being spaced apart from each other on said plate, said first stake extending upwardly through said body corresponding to said female bird having said plate being aligned with said flap.

5. The assembly according to claim 4, further comprising a plurality of bolts, each of said bolts extending through said flap and an associated one of said apertures such that said flap is coupled to said second surface.

6. A fowl decoy assembly comprising:
a decoy comprising a body of a female bird and a body of a male bird, said male bird having a head being movably coupled to said body corresponding to said male bird, said male bird being positioned to mount said female bird, said decoy having a flap being coupled to said head, said flap being positioned within said body corresponding to said male bird;
a string being coupled to said decoy wherein said string is configured to be manipulated, said string being coupled to said head such that said string urges said head to move back and forth when said string is manipulated such that said decoy mimics mating motion of said male bird; and
a stand being configured to penetrate a support surface, said decoy being removably coupled to said stand such that said stand retains said decoy in a natural position, said stand comprising:
a first stake having a bottom end and a top end, said bottom end tapering to a point wherein said bottom end is configured to penetrate the support surface,
a second stake being coupled to said first stake, said second stake having a distal end with respect to said first stake, said second stake having a bend thereon to define a first portion forming an angle with a second portion, said first portion being coupled to and extending laterally away from said first stake having said second portion being oriented parallel with said first stake, said distal end tapering to a point wherein said distal end is configured to penetrate the support surface, said second stake inhibiting said stand from tipping, and
a plate having a first surface and a second surface, said first surface being coupled to said first stake, said plate being aligned with said top end, said plate having a plurality of apertures extending through said first surface and said second surface, said apertures being spaced apart from each other on said plate, said first stake extending upwardly through said body corresponding to said female bird having said plate being aligned with said flap; and
a plurality of bolts, each of said bolts extending through said flap and an associated one of said apertures such that said flap is coupled to said second surface.
